(19) United States
(12) Patent Application Publication
(10) Pub. No.: US 2026/0214017 A1
(43) Pub. Date: Jul. 23, 2026

(54) ACCESS CUSTOMER PREMISES EQUIPMENT DEVICE WITH IMPAIRMENT IDENTIFICATION MACHINE LEARNING MODEL AND REINFORCEMENT LEARNING MITIGATION MODEL

(71) Applicant: Charter Communications Operating, LLC, St. Louis, MO (US)

(72) Inventors: Deependra Singh Rawat, Highlands Ranch, CO (US); Shlomo Ovadia, Denver, CO (US)

(73) Assignee: Charter Communications Operating, LLC, St. Louis, MO (US)

(21) Appl. No.: 19/028,282

(22) Filed: Jan. 17, 2025

(51) Int. Cl. H04L 41/16; H04L 41/0631

(52) U.S. Cl. CPC H04L 41/16; H04L 41/0631

(57) ABSTRACT

Methods and systems for impairment identification and mitigation recommendation using pretrained machine learning models on an access customer premises equipment (CPE) device. The access CPE device includes pretrained impairment machine learning models to identify an impairment type present in data received by the access CPE device, a pretrained mitigation action machine learning model to recommend mitigation actions based on the identified impairment type, and send the identified impairment type and the mitigation actions to an analytics processing platform, and a reward function engine connected to the pretrained mitigation action machine learning model, the reward function engine receives a mitigation instruction based on an assessment by the analytics processing platform of identified impairment types and mitigation actions received from multiple access CPE devices, and apply a positive or negative reward type based on comparison of the mitigation instruction and the mitigation actions recommended by the pretrained mitigation action machine learning model.

### TECHNICAL FIELD

This disclosure relates to coaxial cable networks. More specifically, an access customer premises equipment device is deployed with multiple machine learning models to identify impairments and recommend mitigation actions.

### BACKGROUND

Service providers provide data, voice, video, Internet, and other services (collectively “services”) to its customers through an extensive network of fiber and coaxial cables with in-line cascaded RF amplifiers and taps (collectively a “coaxial network” or a “hybrid fiber-coaxial (HFC) network”) that serve millions of residential subscribers and small-medium size businesses using different types of access devices including, but not limited to, D3.1 embedded multimedia terminal adapter (eMTA), advanced wireless gateway (AWG), and 1/10G Ethernet passive optical network (EPON) optical network unit (ONU) (collectively “access customer premises equipment (CPE) device”). The coaxial network is typically built with cascaded RF trunk and distribution amplifiers using a tree-and branch architecture. There can be operational issues and/or impairments with the coaxial network and the RF amplifiers deployed in or on the coaxial network. There are many different types of impairments that occur on the coaxial network and/or cable plant that may negatively impact the Quality of Experience (QoE) of the subscriber.

### SUMMARY

Disclosed is an access customer premises equipment (CPE) device and method for identifying impairments and providing mitigation recommendations using pretrained machine learning models. In implementations, the access customer premises equipment (CPE) device includes one or more pretrained impairment machine learning models configured to identify an impairment type present in data received by the access CPE device, a pretrained mitigation action machine learning model configured to recommend one or more mitigation actions based on the identified impairment type, and send the identified impairment type and the one or more mitigation actions to an analytics processing platform, a reward function engine connected to the pretrained mitigation action machine learning model, the reward function engine configured to receive, from the analytics processing platform, a mitigation instruction based on an assessment by the analytics processing platform of identified impairment types and one or more mitigation actions received from multiple access CPE devices, and apply one of a positive or negative reward type based on comparison of the mitigation instruction and the one or more mitigation actions recommended by the pretrained mitigation action machine learning model.

### BRIEF DESCRIPTION OF THE DRAWINGS

The disclosure is best understood from the following detailed description when read in conjunction with the accompanying drawings. It is emphasized that, according to common practice, the various features of the drawings are not to scale. On the contrary, the dimensions of the various features are arbitrarily expanded or reduced for clarity.

FIG. 1 is a diagram of an example of a coaxial network architecture in accordance with the teachings described herein.

FIG. 1A is a diagram of an example of a network architecture in accordance with embodiments of this disclosure.

FIG. 2 is a diagram of an example of a coaxial network architecture and an access customer premises equipment (CPE) device in accordance with the teachings described herein.

FIG. 3 is a photograph or image capture of an example of a radio frequency (RF) impairment in accordance with the teachings described herein.

FIG. 4 is a photograph or image capture of an example of RF impairments in accordance with the teachings described herein.

FIG. 5 is a photograph or image capture of an example of RF impairments in accordance with the teachings described herein.

FIG. 6 is a flowchart of an example method for identifying impairments and providing mitigation recommendations using pretrained machine learning models on an access CPE device in accordance with the teachings described herein.

FIG. 7 is a block diagram of an example of a device in accordance with the teachings described herein.

### DETAILED DESCRIPTION

Reference will now be made in greater detail to embodiments, examples of which are illustrated in the accompanying drawings. Wherever possible, the same reference numerals will be used throughout the drawings and the description to refer to the same or like parts.

As used herein, the terminology “server”, “computer”, “computing device or platform”, or “cloud computing system” includes any unit, or combination of units, capable of performing any method, or any portion or portions thereof, disclosed herein. For example, the “server”, “computer”, “computing device or platform”, or “cloud computing system” may include at least one or more processor(s).

As used herein, the terminology “processor” or “processing circuitry” indicates one or more processors, such as one or more special purpose processors, one or more digital signal processors, one or more microprocessors, one or more controllers, one or more microcontrollers, one or more application processors, one or more central processing units (CPU)s, one or more graphics processing units (GPU)s, one or more digital signal processors (DSP)s, one or more application specific integrated circuits (ASIC)s, one or more application specific standard products, one or more field programmable gate arrays, any other type or combination of integrated circuits, one or more state machines, or any combination thereof.

As used herein, the term “engine” may include software, hardware, or a combination of software and hardware. An engine may be implemented using software stored in the memory subsystem. Alternatively, an engine may be hard-wired into processing circuitry. In some cases, an engine includes a combination of software stored in the memory and hardware that is hard-wired into the processing circuitry.

As used herein, the terminology “memory” indicates any computer-usable or computer-readable medium or device that can tangibly contain, store, communicate, or transport any signal or information that may be used by or in connection with any processor. For example, a memory may be one or more read-only memories (ROM), one or more random access memories (RAM), one or more registers, low power double data rate (LPDDR) memories, one or more cache memories, one or more semiconductor memory devices, one or more magnetic media, one or more optical media, one or more magneto-optical media, or any combination thereof.

As used herein, the term “memory” includes one or more memories, where each memory may be a computer-readable medium. A memory may encompass memory hardware units (e.g., a hard drive or a disk) that store data or instructions in software form. Alternatively or in addition, the memory may include data or instructions that are hard-wired into processing circuitry. The memory may include a single memory unit or multiple joint or disjoint memory units, which each of the multiple joint or disjoint memory units storing all or a portion of the data described as being stored in the memory.

As used herein, the terminology “instructions” may include directions or expressions for performing any method, or any portion or portions thereof, disclosed herein, and may be realized in hardware, software, or any combination thereof. For example, instructions may be implemented as information, such as a computer program, stored in memory that may be executed by a processor to perform any of the respective methods, algorithms, aspects, or combinations thereof, as described herein. For example, the memory can be non-transitory. Instructions, or a portion thereof, may be implemented as a special purpose processor, or circuitry, that may include specialized hardware for carrying out any of the methods, algorithms, aspects, or combinations thereof, as described herein. In some implementations, portions of the instructions may be distributed across multiple processors on a single device, on multiple devices, which may communicate directly or across a network such as a local area network, a wide area network, the Internet, or a combination thereof.

As used herein, the term “application” refers generally to a unit of executable software that implements or performs one or more functions, tasks, or activities. For example, applications may perform one or more functions including, but not limited to, telephony, web browsers, e-commerce transactions, media players, scheduling, management, smart home management, entertainment, and the like. The unit of executable software generally runs in a predetermined environment and/or a processor.

As used herein, the terminology “determine” and “identify,” or any variations thereof includes selecting, ascertaining, computing, looking up, receiving, determining, establishing, obtaining, or otherwise identifying or determining in any manner whatsoever using one or more of the devices and methods are shown and described herein.

As used herein, the terminology “example,” “the embodiment,” “implementation,” “aspect,” “feature,” or “element” indicates serving as an example, instance, or illustration. Unless expressly indicated, any example, embodiment, implementation, aspect, feature, or element is independent of each other example, embodiment, implementation, aspect, feature, or element and may be used in combination with any other example, embodiment, implementation, aspect, feature, or element.

As used herein, the terminology “or” is intended to mean an inclusive “or” rather than an exclusive “or.” That is, unless specified otherwise, or clear from context, “X includes A or B” is intended to indicate any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from the context to be directed to a singular form.

As used herein, unless explicitly stated otherwise, any term specified in the singular may include its plural version. For example, “a computer that stores data and runs software,” may include a single computer that stores data and runs software or two computers—a first computer that stores data and a second computer that runs software. Also “a computer that stores data and runs software,” may include multiple computers that together stored data and run software. At least one of the multiple computers stores data, and at least one of the multiple computers runs software.

Further, for simplicity of explanation, although the figures and descriptions herein may include sequences or series of steps or stages, elements of the methods disclosed herein may occur in various orders or concurrently. Additionally, elements of the methods disclosed herein may occur with other elements not explicitly presented and described herein. Furthermore, not all elements of the methods described herein may be required to implement a method in accordance with this disclosure and claims. Although aspects, features, and elements are described herein in particular combinations, each aspect, feature, or element may be used independently or in various combinations with or without other aspects, features, and elements.

Further, the figures and descriptions provided herein may be simplified to illustrate aspects of the described teachings and/or embodiments that are relevant for a clear understanding of the herein disclosed processes, machines, and/or manufactures, while eliminating for the purpose of clarity other aspects that may be found in typical similar devices, systems, and methods. Those of ordinary skill may thus recognize that other elements and/or steps may be desirable or necessary to implement the devices, systems, and methods described herein. However, because such elements and steps do not facilitate a better understanding of the disclosed teachings and/or embodiments, a discussion of such elements and steps may not be provided herein. However, the present disclosure is deemed to inherently include all such elements, variations, and modifications to the described aspects that would be known to those of ordinary skill in the pertinent art in light of the discussion herein.

Described herein is an access customer premises equipment (CPE) device and method for identifying impairments and providing mitigation recommendations using pretrained machine learning models.

In implementations, an analytics platform at a service provider back office can include, but is not limited to, a pretrained machine learning model to process and/or handle different types of cable network impairments along with mitigation plans for these impairments. An access CPE device can be embedded and/or deployed with a pretrained machine learning model to identify at the access CPE device location a type of observed radio frequency (RF) impairment and a pretrained machine learning model to identify a type of observed non-RF and/or device specific impairment. In a non-limited example, the pretrained machine learning models can be multi-class classification models. The access CPE device can be embedded and/or deployed with a pretrained machine learning model to provide a mitigation action based on the identified impairment. The access CPE device can receive data over a coaxial network. The access CPE device can send an observed impairment along with a recommended mitigation action and/or instruction to the analytics platform. The analytics platform can receive observed impairments and mitigation actions from all the access CPE devices. The analytics platform can determine and send a mitigation action and/or alert to the relevant end points. The analytics platform can send the mitigation action and/or alert to the access CPE devices as feedback to the pretrained machine learning model which provides the mitigation action. The access CPE device can report the updated test results to the analytics platform.

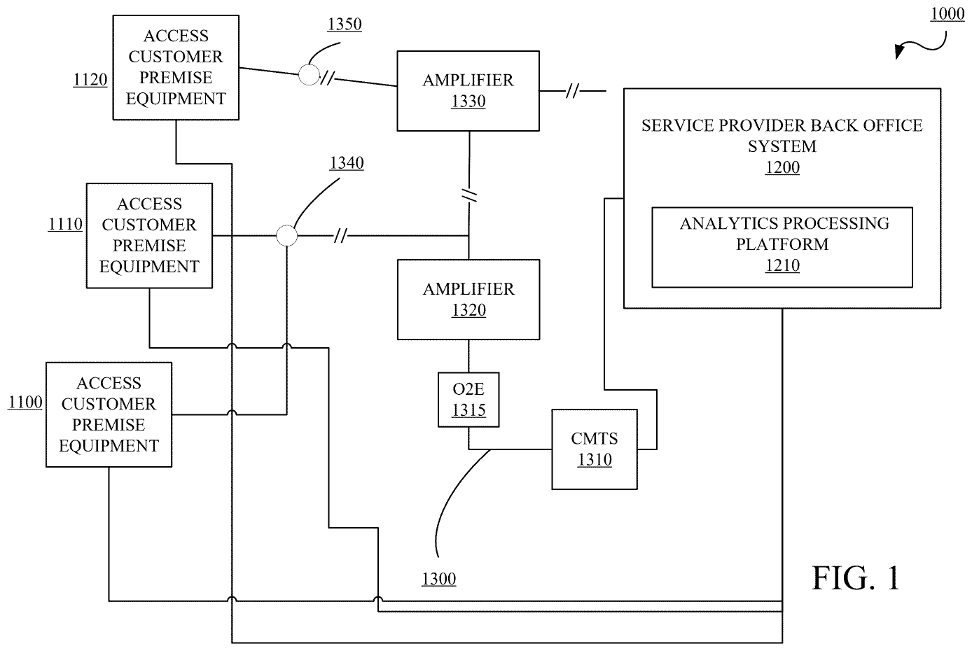

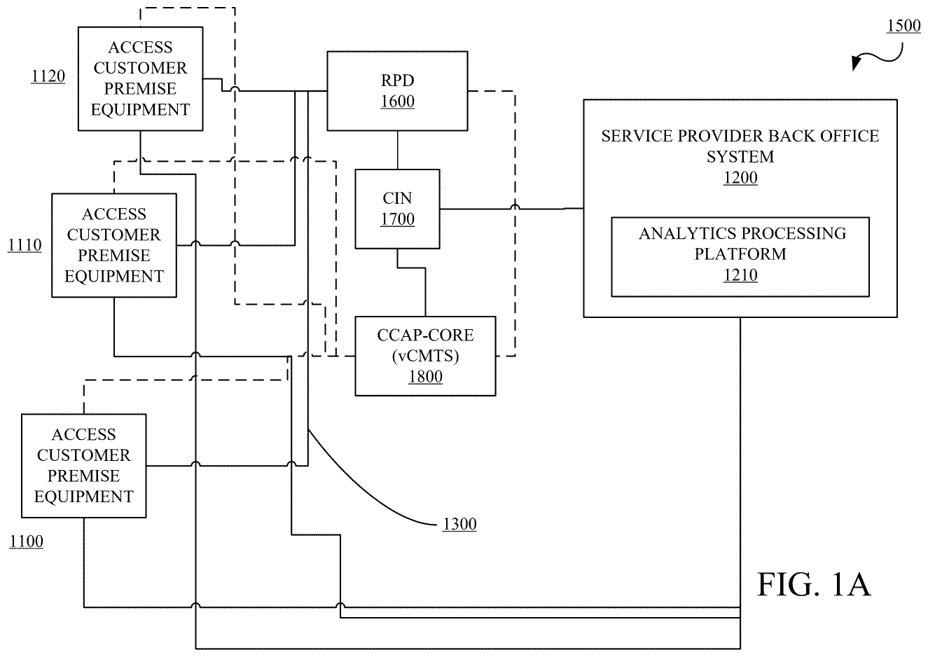

FIG. 1 is a diagram of an example network architecture 1000. The network architecture 1000 can include access customer premises equipment (CPE) devices 1100, 1110, and 1120, a service provider back-office system 1200, a hybrid fiber-coaxial cable (HFC), a coaxial cable system, and/or combinations thereof (collectively “cable system”) 1300, a cable modem termination system (CMTS) 1310, amplifiers 1320 and 1330, and taps 1340 and 1350. The access CPE devices 1100, 1110, and 1120 are connected to or in communication with (collectively “connected to”) the service provider back-office system 1200 via the cable system 1300 using the taps 1340 and 1350, the amplifiers 1320 and 1330, and the CMTS 1310, as appropriate and applicable. The access CPE devices 1100 and 1110 are connected to the tap 1340, which in turn is connected to the amplifier 1320, the CMTS 1310, and the service provider back-office system 1200. The access CPE device 1120 is connected to the tap 1350, which in turn is connected to the amplifier 1330, the amplifier 1320, the CMTS 1310, and the service provider back-office system 1200. The number of components shown herein are illustrative and there may be more or less in the network architecture 1000. The network architecture 1000 and the components therein may include other elements which may be desirable or necessary to implement the devices, systems, and methods described herein. However, because such elements and steps are well known in the art, and because they do not facilitate a better understanding of the disclosed embodiments, a discussion of such elements and steps may not be provided herein.

The access CPE devices 1100, 1110, and 1120 can be routers, set-top boxes, cable modems, gateways, wireless gateway, embedded multimedia terminal adapters (eMTA), advanced wireless gateways (AWG), Ethernet passive optical network (EPON) optical network units (ONUs), integrated modem and router, set-top box embedded modem and router, and the like which provides connectivity including Internet connectivity, wired connectivity, wireless connectivity, data, voice over IP, and combinations thereof. The access CPE devices 1100, 1110, and 1120 can be deployed, for example, at a customer premises, residences, offices, and the like. The access CPE devices 1100, 1110, and 1120 can receive data over the cable system 1300, identify impairments, determine mitigation actions, and send the identified impairments and the mitigation actions to the service provider back-office system 1200.

The service provider back-office system 1200 can include multiple components to provide services to customers via the access CPE devices 1100, 1110, and 1120. The service provider back-office system 1200 can include service provider servers, networks, or clouds including, but not limited to, an analytics processing or service provider processing platform and/or server 1210. The analytics processing or service provider processing platform and/or server 1210 can receive identified impairments and mitigation actions from the multiple access CPE devices 1100, 1110, and 1120. The analytics processing or service provider processing platform and/or server 1210 can determine a mitigation instruction, plan, and/or alert based on the received identified impairments and mitigation actions, which in turn can be sent to appropriate devices and/or platforms for execution and/or implementation. In implementations, the analytics processing or service provider processing platform and/or server 1210 is and/or can implement a pretrained machine learning model which is trained on different types of impairments and mitigation actions associated with the different types of impairments.

The CMTS 1310 can provide cable, television, Internet, voice, and like services to the access CPE devices 1100, 1110, and 1120. The CMTS 1310 can communicate via an optical-to-electrical (O2E) converter 1315 (also known as a fiber node) with the amplifiers 1320 and 1330 and the service provider back-office system 1200 with respect to data and mitigation instructions.

The amplifiers 1320 and 1330 can be a RF in-line amplifier unit.

The coaxial taps 1340 and 1350 are used to connect premises, which include the access CPE devices 1100, 1110, and 1120, to the cable system 1300.

FIG. 1A is a diagram of an example network architecture 1500, which is a distributed access architecture (DAA). The network architecture 1500 can operate as described with respect to the network architecture 1000 except as described herein. The network architecture 1500 can include the access CPE devices 1100, 1110, and 1120, the service provider back-office system 1200, the cable system 1300, a remote physical device (RPD) 1600, a converged interconnect network (CIN) 1700, and a Converged Cable Access Platform (CCAP) and/or virtual cable modem termination system (vCMTS) 1800. The access CPE devices 1100, 1110, and 1120 are connected to or in communication with (collectively “connected to”) the service provider back-office system 1200 via the cable system 1300, the RPD 1600, the CIN 1700, and the vCMTS 1800, as appropriate and applicable. The number of components shown herein are illustrative and there may be more or less in the network architecture 1000. The network architecture 1000 and the components therein may include other elements which may be desirable or necessary to implement the devices, systems, and methods described herein. However, because such elements and steps are well known in the art, and because they do not facilitate a better understanding of the disclosed embodiments, a discussion of such elements and steps may not be provided herein.

The vCMTS 1800 typically contains both a CMTS core for DOCSIS and an Edge Quadrature Amplitude Modulation (QAM) (EQAM) core for Video. The EQAM functions could also be in an auxiliary (video) core. The RPD contains mainly PHY related circuitry, such as downstream QAM modulators, upstream QAM demodulators, together with pseudo-wire logic to connect to the CCAP core. The RPD 1600 is a physical layer converter whose functions are to convert downstream DOCSIS, MPEG video and out-of-band (OOB) signals received from a vCMTS 1800 over a digital medium such as Ethernet or passive optical network (PON) to analog for transmission over RF or linear optics, and to convert upstream DOCSIS and OOB signals received from an analog medium such as RF or linear optics to digital for transmission over Ethernet or PON to a CCAP core.

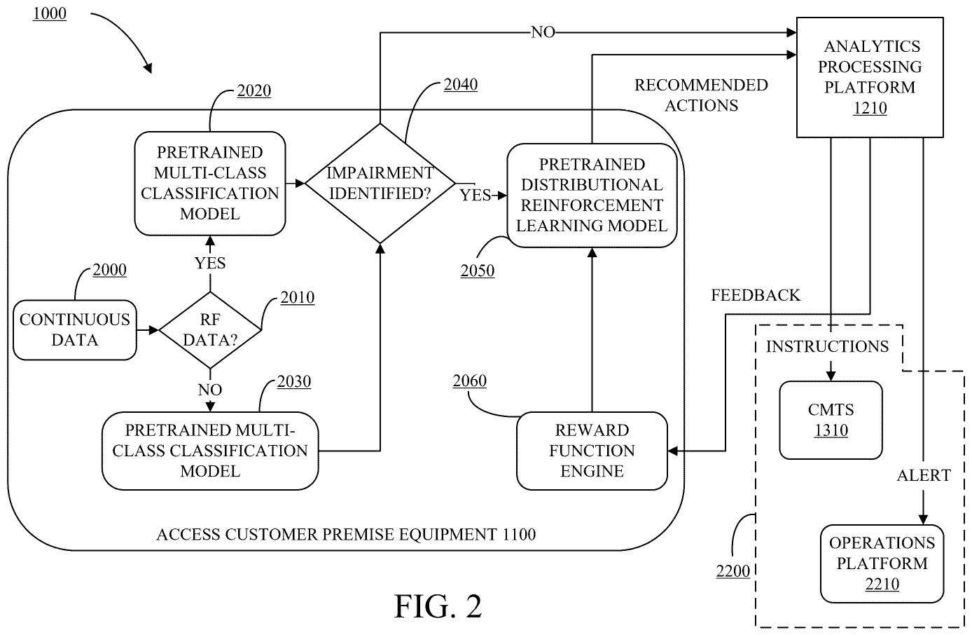

FIG. 2 is a diagram of an example access CPE device 1100 in the network architecture 1000. The network architecture 1000 can include the access CPE device 1100, the analytics processing or service provider processing platform and/or server 1210, and end point devices 2200, which includes the CMTS 1310 and an operations platform 2210. The number of components shown herein are illustrative and there may be more or less in the network architecture 1000. The network architecture 1000 and the components therein may include other elements which may be desirable or necessary to implement the devices, systems, and methods described herein. However, because such elements and steps are well known in the art, and because they do not facilitate a better understanding of the disclosed embodiments, a discussion of such elements and steps may not be provided herein.

In implementations, the access CPE device 1100 can include, but is not limited to, a pretrained machine learning model 2020, a pretrained machine learning model 2030, and a pretrained distributional reinforcement machine learning model 2050.

In implementations, the pretrained machine learning model 2020 can be trained at a service provider using the cable network data prior to deployment on the access CPE devices, such as the access CPE device 1100. The pretrained machine learning model 2020 can be trained for detection of RF impairments on the cable network (the “pretrained RF impairment model”). In implementations, the pretrained machine learning model 2020 is a multi-class classification model. The pretrained machine learning model 2020 can be trained on a large dataset with various type of impairments collected over a period of time from field deployed access CPE devices. The dataset for the pretrained machine learning model 2020 can include different classes of network impairments (both upstream and downstream), which will help multi-class classification models to learn different types (i.e. classes) of impairments. To achieve higher accuracy and eliminate false positive results, the multi-class classification models can tune its hyperparameters using a Grid Search. A hyperparameter is a parameter that is set before the training process begins, essentially controlling the learning process itself, unlike model parameters which are learned from the data during training. Hyperparameters influence aspects like model complexity, learning rate, and overall model architecture, and are often tuned to optimize model performance. The Grid Search is a method used in machine learning to find the optimal set of hyperparameters for a model by systematically testing every possible combination of values within a predefined range for each hyperparameter, essentially creating a “grid” of parameter values and evaluating the model's performance on each combination to identify the best performing set of hyperparameters.

The Grid search is an iterative process that divides the training data into partitions. In each iteration, one partition is used for testing and the rest are used for training. The process records the model's performance in each iteration and averages all the performances at the end. Grid search is time-consuming because it builds a model for every combination of hyperparameters and evaluates each model and hence, this training and tuning will be done at the service provider system. The pre-trained fine-tuned model (i.e., the pretrained machine learning model 2020 can be converted to TensorFlow Lite models, which use a portable format called Flat Buffers identified by a .tflite file extension, and then embedded into the access CPE device firmware image. The TFLite models can include metadata with human-readable model descriptions and machine-readable data. This metadata can be used to automatically generate pre-processing and post-processing pipelines. This format includes the model's metadata in a separate JSON file. The JSON file can contain information such as the model's author, license, description, and version.

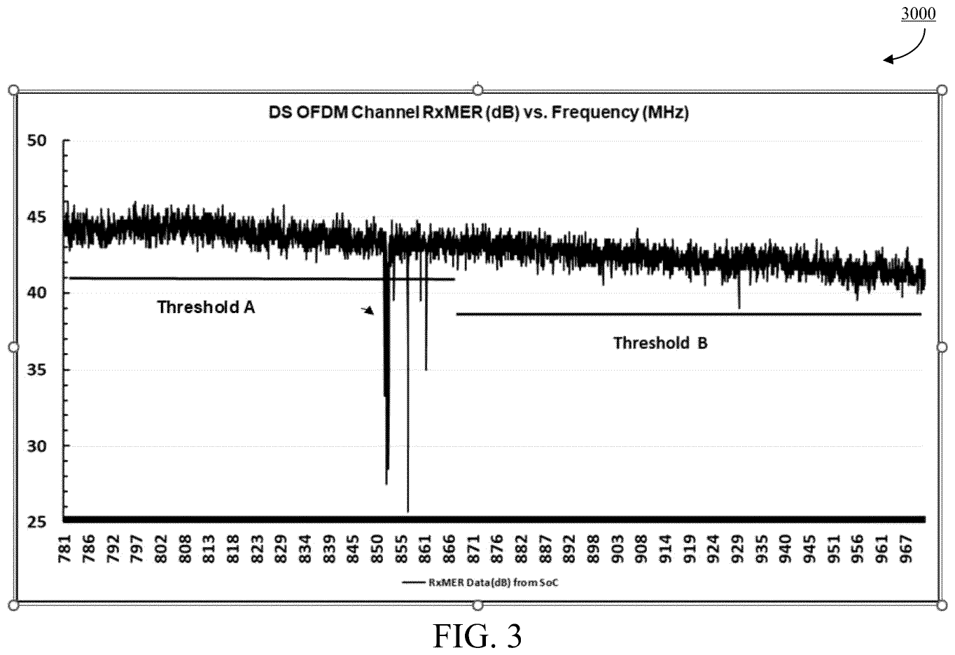

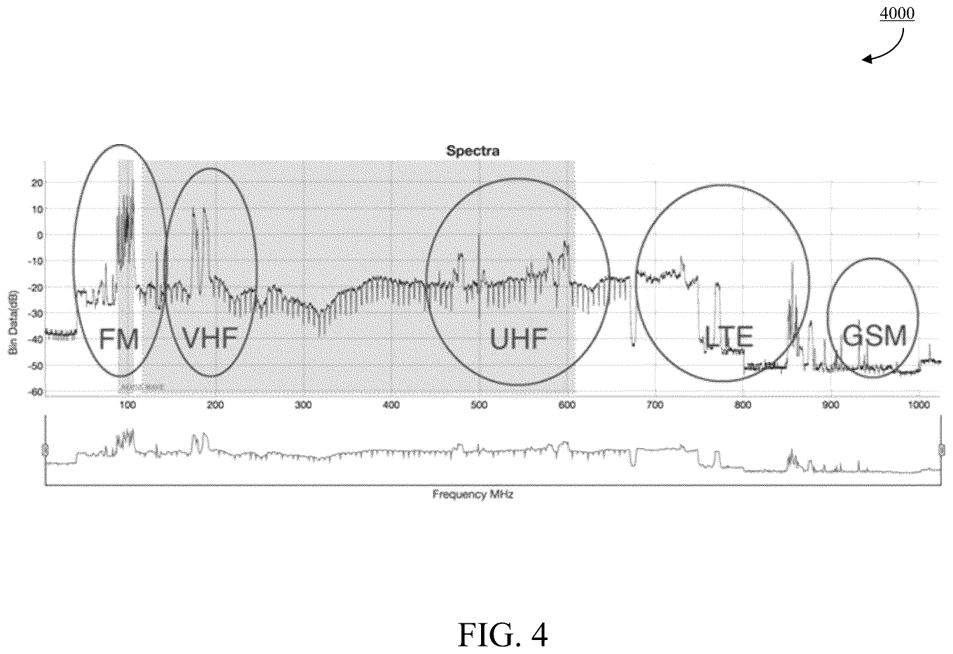

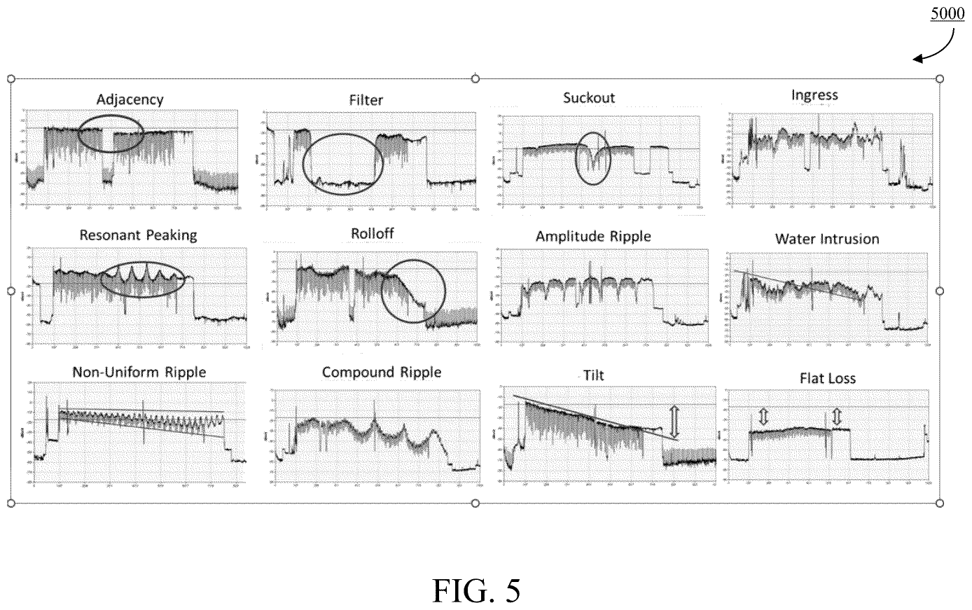

In implementations, the RF impairments can be impairments which can appear in a downstream RF spectrum of a connected modem such as, but not limited to, in-band LTE interference, spectral tilt, micro-reflections, ingress noise, suck-outs, and/or resonant peaks. In a non-limiting example, FIG. 3 is a plotted RF data capture of an example of a radio frequency (RF) impairment in accordance with the teachings described herein. In particular, FIG. 3 shows LTE in-band interference with spectral Tilt in a downstream OFDM channel. In a non-limiting example, FIG. 4 is a photograph or image capture of an example of RF impairments in accordance with the teachings described herein. In particular, FIG. 4 shows downstream wideband spectrum analysis of RF spectrum including interference as provided in CableLabs PNM v02. In a non-limiting example, FIG. 5 is a photograph or image capture of an example of RF impairments in accordance with the teachings described herein. In particular, FIG. 5 shows examples of RF spectral impairments as provided in CableLabs PNM v05-230927.

In implementations, the pretrained machine learning model 2030 can be trained at a service provider prior to deployment on the access CPE devices, such as the access CPE device 1100. The pretrained machine learning model 2030 can be trained for detection of non-RF related impairments on the cable network and/or at the access CPE device (the “pretrained non-RF impairment model”). Non-RF related impairment of access CPE device 1100 can include impairments such as high operating device temperature (>55° C.), high memory utilization (>90%) for long a period of time, memory leaks, frequent software system crushes, etc. In implementations, the pretrained machine learning model 2030 is a multi-class classification model. The pretrained machine learning model 2030 can be trained on a large dataset with various type of impairments collected over a period of time from field deployed access CPE devices. The dataset for the pretrained machine learning model 2020 can include different classes of non-RF related impairments, which will help multi-class classification models to learn different types (i.e. classes) of impairments. To achieve higher accuracy and eliminate false positive results, the multi-class classification models can tune its hyper-parameters using the Grid Search. The pre-trained fine-tuned model (i.e., the pretrained machine learning model 2030 can be converted to TensorFlow Lite models and deployed as described herein.

In implementations, the pretrained machine learning model 2050 can be trained at a service provider prior to deployment on the access CPE devices, such as the access CPE device 1100. The pretrained machine learning model 2050 can be trained to provide a mitigation action for an identified impairment (the “pretrained mitigation action model”). In implementations, the pretrained machine learning model 2050 is a reinforcement learning model. In implementations, the pretrained machine learning model 2050 is a Distributional Reinforcement Learning with Quantile Regression (QR-DQN) model. QR-DQN builds on the Deep Q-Network (DQN) by explicitly modeling the distribution of returns instead of predicting the mean return. It does this by regressing a discrete set of quantiles of a q-value, minimizing the quantile regression loss between the predicted quantiles and the target quantiles, and computing the return quantiles on fixed, uniform quantile fractions. Regressing a discrete set of quantiles of a “q-value” refers to the process of using a statistical technique called quantile regression to model the relationship between a set of predictor variables and different quantiles (specific percentiles) of a “q-value” which is typically a predicted value in a reinforcement learning context, like the expected future reward from a given state-action pair, rather than a single mean value; essentially, it allows you to analyze how the distribution of the q-value changes based on different input features.

The QR-DQN pretrained machine learning model 2050 can be trained on a large dataset with various types of impairments and associated mitigation actions. In QR-DQN models, for each state-action pair instead of estimating a single value, a distribution of values is learned. In this instance, different impairments will serve as different states. The distribution of the values, rather than just the average, can improve the policy. This means that quantiles are learned with threshold values attached to certain probabilities in the cumulative distribution function. That is, the pretrained machine learning model 2050 can provide multiple mitigation actions, each mitigation action having a defined probability. The pretrained machine learning model 2050 can provide the specific probabilities for each of the mitigation actions using QR-DQN techniques known to one of ordinary skill in art. The pre-trained fine-tuned model (i.e., the pretrained machine learning model 2050 can be converted to TensorFlow Lite models and deployed as described herein.

Operationally, with reference to FIG. 1 and FIG. 2, the access CPE device 1100 can receive data sent over the cable system 1300 and/or process data that can be generated by the access CPE device 1100 (2000). The data can include RF data, non-RF data, and/or combinations thereof. The access CPE device 1100 can determine the type of data (2010). RF data is processed by the pretrained machine learning model 2020 and non-RF data is processed by the pretrained machine learning model 2030.

At block 2040, if an impairment is identified but not previously classified, the identified impairment can be sent to the analytics processing platform 1210. The analytics processing platform 1210 can store the identified impairment to the dataset to pretrain a future impairment identification model for an updated release. If the pretrained machine learning model for RF data 2020 or pretrained machine learning model for non-RF data 2030 can classify the identified impairment, then the identified impairment can be sent to the pretrained machine learning model 2050. The pretrained machine learning model 2050 can determine one or more mitigation actions with assigned probabilities and send the one or more mitigation actions with assigned probabilities to the analytics processing platform 1210.

The analytics processing platform 1210 can receive one or more mitigation actions with assigned probabilities from multiple access CPE devices. In implementations, the analytics processing platform 1210 can collect similar mitigation actions with assigned probabilities from access CPE devices within a same service group, access CPE devices having a same CMTS, and/or access CPE devices from similar type of CMTS group. The analytics processing platform 1210 can analyze the dataset to determine the impact of the impairment. In non-illustrative examples, the analytics processing platform 1210 can determine whether the identified impairment appears in nearby cable modems connected to the same Service Group (SG), whether the identified impairment appears in other SGs in the same CMTS or even other similar CMTSs in the same geographic area, whether the identified impairment is new or previously observed, does the identified impairment appear in certain access CPE device types, is the identified impairment persistent or intermittent, and/or combinations thereof.

Based on the assessment and/or analysis, the analytics processing platform 1210 can perform one or more actions.

In implementations, the analytics processing platform 1210 can send a set of actions and/or instructions to a corresponding CMTS (i.e., connected to the access CPE device such as the CMTS 1310) to mitigate the identified impairment, alert an operations platform 2210 if the identified impairment is local to the access CPE device, alert an operations platform 2210 in all cases, and/or combinations thereof.

In implementations, the analytics processing platform 1210 can continue to collect data from various field-deployed access CPE devices if the identified impairment is a new impairment, and there is no mitigation plan.

In implementations, the analytics processing platform 1210 can send a set of actions and/or/instructions to a reward function engine 2060 in the connected access CPE device 1100 as a feedback loop. In this instance, the reward function engine 2060 can compare the mitigation actions provided by the pretrained machine learning model 2050 against the mitigation actions provided by the analytics processing platform 1210. If the recommended mitigation actions provided by the pretrained machine learning model 2050 and the analytics processing platform 1210 are similar, then the reward function engine 2060 can calculate a positive reward, such as 1.0, and send it to pretrained machine learning model 2050 to reinforce the determination by the pretrained machine learning model 2050. If the recommended mitigation actions provided by the pretrained machine learning model 2050 and the analytics processing platform 1210 are different, then the reward function engine 2060 can calculate a negative reward such as −1.0. In implementations, the reward function engine 2060 can assign a value between, for example, −1 to +1 for each incoming feedback or recommended mitigation action based on a level of difference.

In implementations, for non-RF identified impairments, the analytics processing platform 1210 can send notifications to a service provider's operations platform 2210. The operations platform 2210 can notify an end-user via a service provider application and/or other communications platform about the impairment findings. The operations platform 2210 can ask the end-user to take action to mitigate the observed issues. Such actions may include, but are not limited to, check if the coaxial F-connector to the access CPE device is loose, check if the access CPE device has adequate air circulation, check the access CPE device's status or LEDs, and/or combinations thereof.

In a non-illustrative example, a mitigation action for LTE interference can include generation of a new profile for a Profile Management Application (PMA). The PMA creates a set of optimal profiles for each channel and assigns profiles to access CPE devices. The PMA accomplishes this dynamically by proactively reading data collected from the network. The PMA can create optimized modulation profiles periodically, as well as backup profiles in case of errors. It can also intelligently decide when to roll out profile changes to the network. A single PMA instance can create and configure profiles for a number of CMTSs in a short period of time and help the operator understand the data capacity of each channel. In summary, a centralized server is used by access CPE devices and CMTSs to upload signal quality data. Operators can use the CableLabs DOCSIS Common Collection Framework (DCCF) to run on a data analytics server or also develop their own data collection software. Using the data collected, this application (the PMA) creates optimized profiles per channel. It configures these profiles on the CMTS, assigns access CPE devices to profiles, and can initiate performance tests. The CMTSs can configure profiles for the individual channels, assign the modulation profiles to access CPE devices and ultimately send/receive data using the profiles. The access CPE devices use the profiles defined and assigned by the CMTS to receive/send data. To mitigate the in-band LTE interference and maximize the bit-loading on each of the OFDM channel's subcarriers as shown in FIG. 3, the PMA can either notch-out only the OFDM subcarrier located between 851 MHz and 861 MHz or alternatively, reduce the bit-loadings on these subcarriers from 12 bits/SC (4k-QAM modulation) to 8 bits/SC (256-QAM modulation). Based on the training data and learning, pretrained machine learning model 2050 can suggest these two mitigation plans with probabilities 0.90/0.10 or 0.67/0.33 or 0.80/0.20, respectively, where the probabilities are determined using known techniques. An alternative mitigation plan is for the CMTS to assign an alternative OFDM channel, which is not impacted by the LTE interference. If the LTE interference is persistent, the PMA will customize the modulation profile to the CM for the specific OFDM channel.

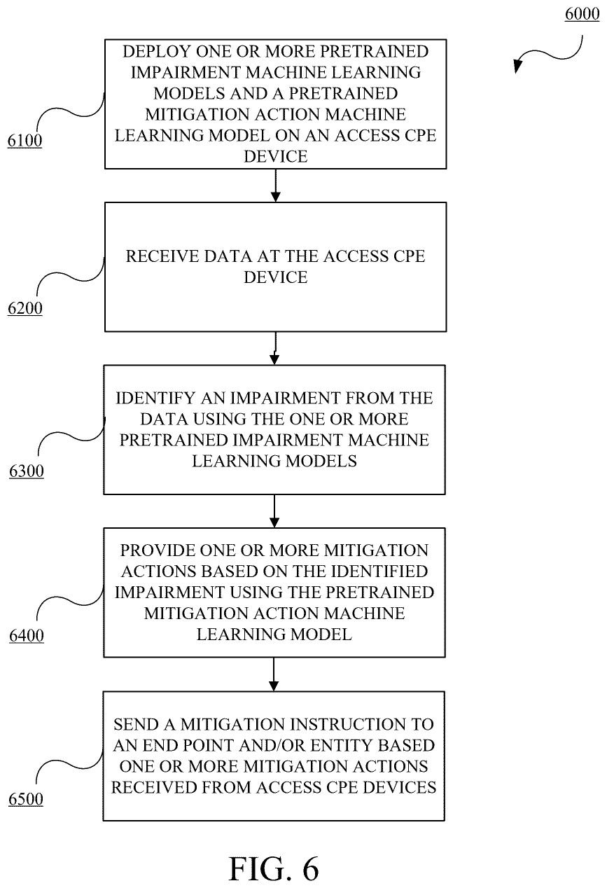

FIG. 6 is a flowchart of an example method 6000 for identifying impairments and providing mitigation recommendations using pretrained machine learning models deployed on access CPE devices in accordance with the teachings described herein. The method 6000 includes: deploying 6100 one or more pretrained impairment machine learning models and a pretrained mitigation action machine learning model on an access CPE device; receiving 6200 data at the access CPE device; identifying 6300 an impairment from the data using the one or more pretrained impairment machine learning models; providing 6400 one or more mitigation actions based on the identified impairment using the pretrained mitigation action machine learning model; and sending 6500 a mitigation instruction to an end point and/or entity based one or more mitigation actions received from access CPE devices. The method 6000 can be implemented, for example, in the access CPE device 1100, 1110, and 1120, the service provider back-office system 1200 and components therein, the CMTS 1310, the analytics processing platform 1210, the device 7000, the processor 7100, the memory/storage 7200, the communications interface 7300, the applications 7400, and the radio frequency device 7500 when available, as appropriate and applicable.

The method includes deploying 6100 one or more pretrained impairment machine learning models and a pretrained mitigation action machine learning model on an access CPE device. A service provider can pretrain one or more machine learning models to identity impairments that can occur on and/or within a cable network and that can occur on and/or within an access CPE device. The pretrain machine learning models for identifying impairments can be deployed and/or embedded on access CPE devices. The access CPE device are then enabled to determine impairments in the field using the pretrained machine learning models. The service provider can pretrain a machine learning model to determine a mitigation action based on an identified impairment that can occur on and/or within the cable network and that can occur on and/or within an access CPE device. The pretrained machine learning model for recommending a mitigation action can be deployed and/or embedded on the access CPE devices. The access CPE devices are then enabled to determine impairments and mitigation actions in the field using the respective pretrained machine learning models.

The method includes receiving 6200 data at the access CPE device. Once in the field, the access CPE devices can continuously receive data over the cable network and/or process data that is generated by the access CPE device 1100. This data can be used to determine if there are impairments to the signal.

The method includes identifying 6300 an impairment from the data using the one or more pretrained impairment machine learning models. The pretrained machine learning models can analyze the data to determine if the signal has interference or is being interfered with as described herein.

The method includes providing 6400 one or more mitigation actions based on the identified impairment using the pretrained mitigation action machine learning model. If an impairment is determined, the pretrained mitigation action machine learning model can be used to provide a mitigation action as described herein.

The method includes sending 6500 a mitigation instruction to an end point and/or entity to implement the mitigation instruction. The mitigation instruction based one or more mitigation actions received from access CPE devices. The service provider system can collect identified impairments and mitigation actions from multiple access CPE devices. The aggregated data can be analyzed to determine the impact of the identified impairment. That is, is it applicable to a specific access CPE device, a specific access CPE device type, a service group, a CMTS, geographically, and/or combinations thereof. A mitigation instruction and/or alert can be sent based on analysis of the aggregated data. In implementations, the mitigation instruction and/or alert can be sent to the access CPE device as feedback for a reward function associated with the pretrained mitigation action machine learning model.

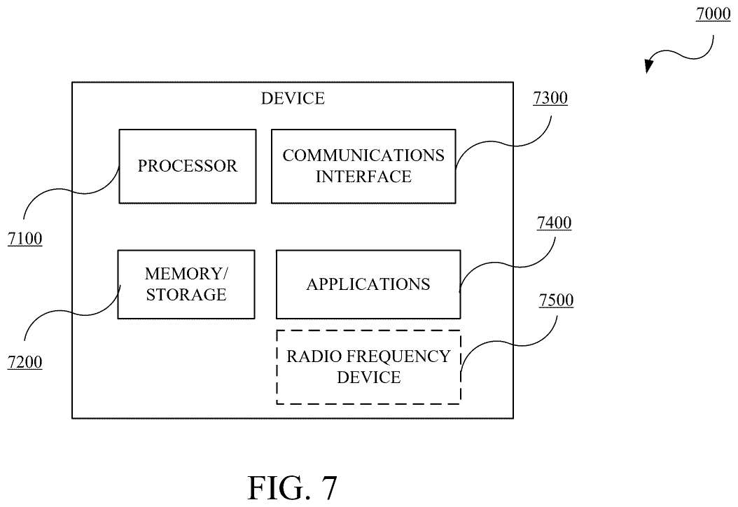

FIG. 7 is a block diagram of an example of a device 7000 in accordance with the teachings described herein. The device 7000 may include, but is not limited to, a processor 7100, a memory/storage 7200, a communication interface 7300, applications 7400, and, if needed, a radio frequency device 7500. The device 7000 may include or implement, for example, the systems and components described with respect to FIGS. 1-2 and the implement the methods of FIG. 6. The applicable or appropriate flows, techniques, or methods described herein may be stored in the memory/storage 7200 and executed by the processor 7100 in cooperation with the memory/storage 7200, the communications interface 7300, the applications 7400, and the radio frequency device 7500 (when applicable), as appropriate. The device 7000 may include other elements which may be desirable or necessary to implement the devices, systems, and methods described herein. However, because such elements and steps do not facilitate a better understanding of the disclosed embodiments, a discussion of such elements and steps may not be provided herein.

Disclosed is an access customer premises equipment (CPE) device for identifying impairments and providing mitigation recommendations using pretrained machine learning models. The access CPE device includes one or more pretrained impairment machine learning models configured to identify an impairment type present in data received by the access CPE device, a pretrained mitigation action machine learning model configured to recommend one or more mitigation actions based on the identified impairment type, and send the identified impairment type and the one or more mitigation actions to an analytics processing platform; and a reward function engine connected to the pretrained mitigation action machine learning model, the reward function engine configured to receive, from the analytics processing platform, a mitigation instruction based on an assessment by the analytics processing platform of identified impairment types and one or more mitigation actions received from multiple access CPE devices, and apply one of a positive or negative reward type based on comparison of the mitigation instruction and the one or more mitigation actions recommended by the pretrained mitigation action machine learning model.

In implementations, the one or more pretrained impairment machine learning models further includes a pretrained radio frequency (RF) impairment machine learning model configured to identify RF impairment types present in the data. In implementations, the one or more pretrained impairment machine learning models further includes a pretrained non-radio frequency (RF) impairment machine learning model configured to identify non-RF impairment types present in the data. In implementations, the one or more pretrained impairment machine learning models are multi-class classification models configured to learn different types of impairments. In implementations, the pretrained mitigation action machine learning model is a reinforcement learning model. In implementations, the pretrained mitigation action machine learning model is a Distributional Reinforcement Learning with Quantile Regression (QR-DQN) model. In implementations, the one or more mitigation actions are multiple mitigation actions and the pretrained mitigation action machine learning model is further configured to provide a probability for each of the multiple mitigation actions.

Disclosed is a system for identifying impairments and providing mitigation recommendations using pretrained machine learning models. The system includes a service provider processing platform, a cable access network configured to carry signals, and access customer premises equipment (CPE) devices connected to the cable access network, an access CPE device includes a pretrained machine learning model configured to identify an impairment in a signal received via the cable access network, and a pretrained machine learning model configured to send one or more mitigation recommendations for the identified impairment to the service provider processing platform, where the service provider processing platform is configured to send a mitigation instruction to an end point entity to implement the mitigation instruction, wherein the mitigation instruction is based on the one or more mitigation recommendations received from the access CPE devices and the access CPE device.

In implementations, the access CPE device further includes a reward engine connected to the pretrained machine learning model configured to send the one or more mitigation recommendations, where the service provider processing platform is configured to send the mitigation instruction to the access CPE device, and where the reward engine is configured to apply one a reward based on a comparison of the mitigation instruction and the one or more mitigation recommendations sent by the pretrained machine learning model configured to send the one or more mitigation recommendations. In implementations, the pretrained machine learning model further includes a pretrained radio frequency (RF) impairment machine learning model configured to identify RF impairment types present in the signal, and a pretrained non-radio frequency (RF) impairment machine learning model configured to identify non-RF impairment types present in the signal. In implementations, the pretrained machine learning model is a multi-class classification model configured to learn different types of impairments. In implementations, the pretrained machine learning model configured to send the one or more mitigation recommendations is a reinforcement learning model. In implementations, the pretrained machine learning model configured to send the one or more mitigation recommendations is a Distributional Reinforcement Learning with Quantile Regression (QR-DQN) model. In implementations, the one or more mitigation recommendations are multiple mitigation recommendations and the pretrained machine learning model configured to send the one or more mitigation recommendations is further configured to provide a probability for each of the multiple mitigation recommendations.

Disclosed is a method for identifying impairments and providing mitigation recommendations using pretrained machine learning models. The method includes identifying, by a pretrained impairment machine learning model on an access customer premises equipment (CPE) device, an impairment in a received signal, recommending, by a pretrained mitigation action machine learning model to a service provider processing platform, actions to mitigate the identified impairment, and reinforcement learning, by the pretrained mitigation action machine learning model, based on comparison of an instruction received from the service provider processing platform and the actions, wherein the instruction is based on actions received from access CPE devices and the access CPE device.

In implementations, the method further includes training the pretrained mitigation action machine learning model on a large dataset with various type of actions for identified impairments, and deploying the pretrained mitigation action machine learning model on the access CPE devices. In implementations, the method further includes training the pretrained impairment machine learning model on a large dataset with various type of impairments, and deploying the pretrained impairment machine learning model on the access CPE devices. In implementations, the recommending further includes providing, by the pretrained mitigation action machine learning model to the service provider processing platform, a probability associated with each of the actions. In implementations, the method further includes sending the instruction to an end point entity to implement the instruction. In implementations, the pretrained impairment machine learning model is a multi-class classification model and wherein the pretrained mitigation action machine learning model is a reinforcement learning model.

Although some teachings and/or embodiments herein refer to methods, it will be appreciated by one skilled in the art that they may also be embodied as a system or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “processor,” “device,” or “system.” Furthermore, aspects may take the form of a computer program product embodied in one or more the computer readable mediums having the computer readable program code embodied thereon. For example, the computer readable mediums can be non-transitory. Any combination of one or more computer readable mediums may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electromagnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to CDs, DVDs, wireless, wireline, optical fiber cable, RF, etc., or any suitable combination of the foregoing.

As used herein, the term “computer-readable medium” encompasses one or more computer-readable media. A computer-readable medium may include any storage unit (or multiple storage units) that store data or instructions that are readable by processing circuitry. A computer-readable medium may include, for example, at least one of a data repository, a data storage unit, a computer memory, a hard drive, a disk, or a random access memory. A computer-readable medium may include a single computer-readable medium or multiple computer-readable media. A computer-readable medium may be a transitory computer-readable medium or a non-transitory computer-readable medium.

Computer program code for carrying out operations for aspects may be written in any combination of one or more programming languages, including an object-oriented programming language such as Java, Smalltalk, C++or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects are described herein with reference to flowchart illustrations and/or block diagrams of methods, apparatus (systems) and computer program products according to teachings and/or embodiments. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowcharts and block diagrams in the figures illustrate the architecture, functionality, and operation of possible implementations of systems, methods, and computer program products according to various teachings and/or embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures.

While the disclosure has been described in connection with certain teachings and/or embodiments, it is to be understood that the disclosure is not to be limited to the disclosed teachings and/or embodiments but, on the contrary, is intended to cover various modifications, combinations, and equivalent arrangements included within the scope of the appended claims, which scope is to be accorded the broadest interpretation so as to encompass all such modifications and equivalent structures as is permitted under the law.

What is claimed is:

1. An access customer premises equipment (CPE) device, comprising:
one or more pretrained impairment machine learning models configured to identify an impairment type present in data received by the access CPE device;
a pretrained mitigation action machine learning model configured to:
recommend one or more mitigation actions based on the identified impairment type; and
send the identified impairment type and the one or more mitigation actions to an analytics processing platform; and
a reward function engine connected to the pretrained mitigation action machine learning model, the reward function engine configured to:
receive, from the analytics processing platform, a mitigation instruction based on an assessment by the analytics processing platform of identified impairment types and one or more mitigation actions received from multiple access CPE devices; and
apply one of a positive or negative reward type based on comparison of the mitigation instruction and the one or more mitigation actions recommended by the pretrained mitigation action machine learning model.

2. The access CPE device of claim 1, wherein the one or more pretrained impairment machine learning models further comprises:
a pretrained radio frequency (RF) impairment machine learning model configured to identify RF impairment types present in the data.

3. The access CPE device of claim 1, wherein the one or more pretrained impairment machine learning models further comprises:
a pretrained non-radio frequency (RF) impairment machine learning model configured to identify non-RF impairment types present in the data.

4. The access CPE device of claim 1, wherein the one or more pretrained impairment machine learning models are multi-class classification models configured to learn different types of impairments.

5. The access CPE device of claim 1, wherein the pretrained mitigation action machine learning model is a reinforcement learning model.

6. The access CPE device of claim 1, wherein the pretrained mitigation action machine learning model is a Distributional Reinforcement Learning with Quantile Regression (QR-DQN) model.

7. The access CPE device of claim 1, wherein the one or more mitigation actions are multiple mitigation actions and the pretrained mitigation action machine learning model is further configured to provide a probability for each of the multiple mitigation actions.

8. A system, comprising:
a service provider processing platform;
a cable access network configured to carry signals; and
access customer premises equipment (CPE) devices connected to the cable access network, an access CPE device comprising:
a pretrained machine learning model configured to identify an impairment in a signal received via the cable access network; and
a pretrained machine learning model configured to send one or more mitigation recommendations for the identified impairment to the service provider processing platform,
wherein the service provider processing platform is configured to send a mitigation instruction to an end point entity to implement the mitigation instruction, wherein the mitigation instruction is based on the one or more mitigation recommendations received from the access CPE devices and the access CPE device.

9. The system of claim 8, wherein the access CPE device further comprising:
a reward engine connected to the pretrained machine learning model configured to send the one or more mitigation recommendations,
wherein the service provider processing platform is configured to send the mitigation instruction to the access CPE device; and
wherein the reward engine is configured to apply one a reward based on a comparison of the mitigation instruction and the one or more mitigation recommendations sent by the pretrained machine learning model configured to send the one or more mitigation recommendations.

10. The system of claim 8, wherein the pretrained machine learning model further comprises:
a pretrained radio frequency (RF) impairment machine learning model configured to identify RF impairment types present in the signal; and
a pretrained non-radio frequency (RF) impairment machine learning model configured to identify non-RF impairment types present in the signal.

11. The system of claim 8, wherein the pretrained machine learning model is a multi-class classification model configured to learn different types of impairments.

12. The system of claim 8, wherein the pretrained machine learning model configured to send the one or more mitigation recommendations is a reinforcement learning model.

13. The system of claim 8, wherein the pretrained machine learning model configured to send the one or more mitigation recommendations is a Distributional Reinforcement Learning with Quantile Regression (QR-DQN) model.

14. The system of claim 8, wherein the one or more mitigation recommendations are multiple mitigation recommendations and the pretrained machine learning model configured to send the one or more mitigation recommendations is further configured to provide a probability for each of the multiple mitigation recommendations.

15. A method for identifying impairments and providing mitigation recommendations using pretrained machine learning models, the method comprising:
identifying, by a pretrained impairment machine learning model on an access customer premises equipment (CPE) device, an impairment in a received signal;
recommending, by a pretrained mitigation action machine learning model to a service provider processing platform, actions to mitigate the identified impairment; and
reinforcement learning, by the pretrained mitigation action machine learning model, based on comparison of an instruction received from the service provider processing platform and the actions, wherein the instruction is based on actions received from access CPE devices and the access CPE device.

16. The method of claim 15, further comprising:
training the pretrained mitigation action machine learning model on a large dataset with various type of actions for identified impairments; and
deploying the pretrained mitigation action machine learning model on the access CPE devices.

17. The method of claim 15, further comprising:
training the pretrained impairment machine learning model on a large dataset with various type of impairments; and
deploying the pretrained impairment machine learning model on the access CPE devices.

18. The method of claim 15, wherein the recommending further comprising:
providing, by the pretrained mitigation action machine learning model to the service provider processing platform, a probability associated with each of the actions.

19. The method of claim 15, further comprising:
sending the instruction to an end point entity to implement the instruction.

20. The method of claim 15, wherein the pretrained impairment machine learning model is a multi-class classification model and wherein the pretrained mitigation action machine learning model is a reinforcement learning model.
